(19) United States
(12) Patent Application Publication
(10) Pub. No.: US 2019/0126194 A1
(43) Pub. Date: May 2, 2019

(54) CYCLOHEXANEDIAMINES FOR USE IN GAS SCRUBBING

(71) Applicant: BASF SE, Ludwigshafen am Rhein (DE)

(72) Inventors: Thomas INGRAM, Ludwigshafen (DE); Gustavo Adolfo LOZANO MARTINEZ, Ludwigshafen (DE); Alexander PANCHENKO, Ludwigshafen (DE); Martin ERNST, Ludwigshafen (DE)

(73) Assignee: BASF SE, Ludwigshafen am Rhein (DE)

(21) Appl. No.: 16/306,784

(22) PCT Filed: Jun. 8, 2017
(86) PCT No.: PCT/EP2017/063921

§ 371 Date: Dec. 3, 2018

(30) Foreign Application Priority Data
Jun. 10, 2016 (EP) 16173866.1

(51) Int. Cl. B01D 53/14; C10L 3/10

(52) U.S. Cl. CPC B01D 53/1493; B01D 2252/2041; C10L 3/104; B01D 53/1475

(57) ABSTRACT

1,3-Diaminocyclohexanes of the general formula (I) are suitable for removing carbon dioxide from fluid streams

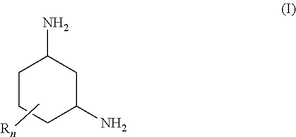

where the radicals R are each, independently of one another, C₁₋₄-alkyl; and n is an integer from 0 to 3. The amino groups of the 1,3-diaminocyclohexane are preferably arranged in trans position relative to one another in the plane of the cyclohexane ring. Absorption media for removing carbon dioxide from fluid streams comprise a) a 1,3-diaminocyclohexane of the general formula (I) and b) optionally at least one tertiary amine and/or a sterically hindered primary or secondary amine. In a process for removing carbon dioxide from fluid streams, the absorption medium is brought into contact with a fluid stream.

The present invention relates to the use of particular cyclohexanediamines for removing carbon dioxide from fluid streams, absorption media comprising these compounds and a process for removing carbon dioxide from fluid streams.

The removal of acidic gases such as CO₂, H₂S, SO₂, CS₂, HCN, COS or mercaptans from fluid streams such as natural gas, refinery gas or synthesis gas is important for various reasons. CO₂ in combination with water which is frequently entrained in the fluid streams can form acids which lead to corrosion of pipes and valves. Carbon dioxide has to be removed from, inter alia, natural gas in such a way that the calorific value of the gas does not drop below the desired value. On the other hand, for further processing in a natural gas liquefaction plant (LNG=liquefied natural gas), CO₂ has to be removed completely.

The content of sulfur compounds in natural gas has to be reduced directly at the natural gas source by means of suitable treatment measures since, in the water frequently entrained by natural gas, the sulfur compounds form acids which are corrosive. For this reason, predefined limit values for the sulfur-comprising impurities have to be adhered to for transport of the natural gas in a pipeline or further processing in a natural gas liquefaction plant (LNG=liquefied natural gas). In addition, numerous sulfur compounds have an unpleasant smell and are toxic even in low concentrations.

Scrubs using aqueous solutions of inorganic or organic bases are used for removing acidic gases. When acidic gases are dissolved in the absorption medium, ions are formed with the bases. The absorption medium can be regenerated by depressurization to a low pressure and/or by stripping, in which case the ionic species react to reform acidic gases and/or are stripped out by means of steam. After the regeneration process, the absorption medium can be reused.

High CO₂ absorption rates are achieved by use of absorption media having a high affinity for CO₂, e.g. primary and secondary alkanolamines. The high affinity for CO₂ means that the CO₂ absorption proceeds strongly exothermically. However, owing to the high absolute value of the enthalpy of the absorption reaction, such absorption media generally also require a relatively high energy consumption for regeneration.

Secondary amines having a high degree of steric hindrance, for example 2-(2-tert-butylaminoethoxy)ethanol, and tertiary amines, e.g. methyldiethanolamine (MDEA), display kinetic selectivity for H₂S over CO₂. These amines do not react directly with CO₂; rather, CO₂ is converted into bicarbonate in a slow reaction with the amine and with water while, in contrast, H₂S reacts immediately in aqueous amine solutions. These amines are therefore particularly suitable for selective removal of H₂S from gas mixtures comprising CO₂ and H₂S.

Sterically unhindered primary or secondary amines, for example piperazine, can act as promoters and accelerate the absorption of CO₂ by tertiary amines as a result of the intermediate formation of a carbamate structure. The absorption rate is high in this direct reaction of the amine with carbon dioxide, but only one CO₂ molecule can be taken up by two amine molecules. Thus, U.S. Pat. No. 4,336,233 discloses a process for removing CO₂ and/or H₂S from gases by means of an aqueous absorption medium comprising MDEA and piperazine. The use of piperazine as CO₂ promoter makes it possible to achieve a many times higher CO₂ absorption rate compared to systems without promoter. However, piperazine is a solid at ambient temperatures; its dusts have a sensitizing action. The transport of piperazine-comprising mixtures is made difficult by the fact that piperazine starts to crystallize out from the solutions even at a comparatively high ambient temperature. When crystallization of the piperazine has commenced, the mixture can no longer be pumped and the contaminated vessels have to be cleaned, which represents a complication.

It is an object of the invention to indicate further compounds which promote rapid absorption of carbon dioxide from fluid streams. The aqueous solutions comprising the compounds should have low crystallization temperatures.

The object is achieved by use of a 1,3-diaminocyclohexane of the general formula (I) for removing carbon dioxide from fluid streams

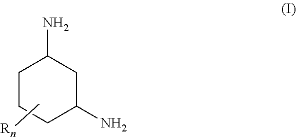

where the radicals R are each, independently of one another, C₁₋₄-alkyl; and n is an integer from 0 to 3.

The invention also provides an absorption medium for removing carbon dioxide from fluid streams, comprising
a) a 1,3-diaminocyclohexane of the general formula (I); and
b) optionally at least one tertiary amine and/or a sterically hindered primary or secondary amine.

The invention additionally provides a process for removing carbon dioxide from a fluid stream, in which the fluid stream is brought into contact with the absorption medium.

In the formula (I), the radical R is preferably methyl or ethyl, in particular methyl. The coefficient n is preferably 1 or 2, in particular 1.

When n is 1 or 2, each of the radicals R is preferably arranged in the a position relative to at least one amino group.

Particular preference is given to 1,3-diaminocyclohexanes of the formula (Ia) or (Ib) or mixtures thereof,

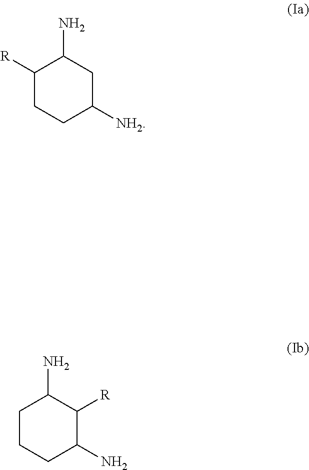

where R has the meaning and preferred meanings indicated above.

Particularly preferred compounds are 4-methylcyclohexane-1,3-diamine, 2-methylcyclohexane-1,3-diamine or mixtures thereof, in particular trans-4-methylcyclohexane-1,3-diamine, trans-2-methylcyclohexane-1,3-diamine or mixtures thereof.

It is assumed that the primary amino groups of the 1,3-diaminocyclohexanes of the general formula (I) act as promoter and accelerate the absorption of CO₂ as a result of the intermediate formation of a carbamate structure. When a radical R is arranged in the a position relative to an amino group, it brings about steric hindrance of this amino group and destabilization of the carbamate bond, which promotes regeneration with elimination of CO₂.

The amino groups in the 1,3-diaminocyclohexane of the general formula (I) are preferably arranged in trans position relative to one another in the plane of the cyclohexane ring. The indication of the configuration as cis or trans in cis- or trans-1,3-diaminocyclohexane relates to the relative arrangement of the amino groups in the plane of the cyclohexane ring. It can be seen that the number of stereoisomers is greater when further substituents in addition to the two amino groups are present on the cyclohexane ring. For the purposes of the present invention, these stereoisomers are assigned to two groups, namely a group in which the amino groups are in cis positions relative to one another and a group in which the amino groups are in trans positions relative to one another.

It has been found that in the case of a mixture of cis- and trans-1,3-diaminocyclohexanes in the presence of carbon dioxide, in particular under conditions of high temperature and/or high CO₂ partial pressure, the cis stereoisomer is selectively converted into the intramolecular urea, namely 2,4-diazabicyclo[3.3.1]nonan-3-one. The urea derivative is thermally stable and is not dissociated during regeneration of the absorption medium. The cis-diaminocyclohexane which has been converted into the urea is no longer available for the reversible absorption of carbon dioxide.

In preferred embodiments, the proportion of trans-diaminocyclohexane, based on the sum of cis- and trans-1,3-diaminocyclohexane, is preferably at least 80%, in particular at least 95%, and particular preference is given to using a substantially pure trans-1,3-diaminocyclohexane. Since trans-diaminocyclohexane is not able to react irreversibly with carbon dioxide, the cyclic capacity of the absorption medium is maintained in the long term.

1,3-Diaminocyclohexanes are obtainable, for example, by hydrogenation of 1,3-phenylenediamines. Such a process is described in U.S. Pat. No. 6,075,167. The 1,3-phenylenediamines are in turn obtainable by reduction of dinitroalkylbenzenes. A suitable starting material is 2,4-dinitrotoluene, which can comprise varying amounts of 2,6-dinitrotoluene.

The hydrogenation of 1,3-phenylenediamines gives a stereoisomeric mixture of cis-and trans-1,3-diaminocyclohexanes in various proportions. Since the physical properties of the stereoisomers are very similar, separation, e.g. by fractional distillation, is very difficult. An increase in the concentration of trans-1,3-diaminocyclohexanes can be effected, for example, by extractive distillation using polyols such as ethylene glycol, 1,2-propanediol, 2-methylpropane-1,3-diol, 1,2-butanediol, 2,3-butanediol, 2-methylbutane-1,2-diol, 3-methylbutane-1,2-diol, 3-methyl-1,3-butanediol, 1,2-pentanediol, 1,3-pentanediol, 2,4-pentanediol, 2,3-pentanediol, 1,2-hexanediol, cis-1,2-cyclopentanediol, trans-1,2-cyclopentanediol, cis-1,2-cyclohexanediol, trans-1,2-cyclohexanediol, 1,3-propanediol, 2-methyl-1,3-propanediol, 2,2,-dimethyl-1,3-propanediol (neopentyl glycol), 1,3-butanediol, 1,2-pentanediol, 2,4-pentanediol, 1,5-pentanediol, 1,3-hexanediol, 2,4-hexanediol, 1,3-cyclobutanediol, 1,3-cyclopentanediol, 1,3-cyclohexanediol, cis- and trans-1,4-butenediol, 1,4-butanediol, 2,3-dimethyl-1,4-butanediol, 2,2-dimethyl-1,4-butanediol, 1,4-pentanediol, 2,3-dimethyl-1,5-pentanediol, 1,4-hexanediol, 1,4-cyclohexanediol, 1,3,6-hexanetriol, 1,2,3-hexanetriol, 1,2,6-hexanetriol, glycerol, diglycerol, sorbitol, pentaerythritol, diethylene glycol, triethylene glycol, dipropylene glycol. Of these, 1,3-propanediol is preferred. The extractant has a greater affinity for cis-1,3-diaminocyclohexane than for trans-1,3-diaminocyclohexane. Thus, trans-enriched 1,3-diaminocyclohexane can be obtained via the top, while the extractant and cis-1,3-diaminocyclohexane remain in the bottoms during the distillation or, in the case of a continuous reaction, are taken off via the bottom.

A separation of cis- and trans-1,3-diaminocyclohexanes can also be effected by reacting a mixture of cis- and trans-1,3-diaminocyclohexanes with carbon dioxide and selectively forming the urea of cis-1,3-diaminocyclohexane. The reaction is, for example, carried out in aqueous solution by heating a CO₂-saturated aqueous solution of a mixture of cis- and trans-1,3-diaminocyclohexanes under autogenous pressure in a pressure vessel. The urea derivative can then easily be separated off from unreacted trans-1,3-diaminocyclohexane, e.g. by precipitation, crystallization or distillation. A two-stage separation process is particularly suitable, in which an increase in the concentration of trans-1,3-diaminocyclohexanes is firstly effected by extractive distillation and the cis-,3-diaminocyclohexane which remains is reacted selectively with carbon dioxide and separated off. In this way, the trans-1,3-diaminocyclohexane can be obtained largely free of cis-1,3-diaminocyclohexane.

The absorption medium of the invention comprises a 1,3-diaminocyclohexane of the general formula (I). In a preferred embodiment, it additionally comprises at least one tertiary amine and/or a sterically hindered primary or secondary amine.

In general, the concentration of the tertiary amine and/or sterically hindered primary or secondary amine in the absorption medium is from 10 to 60% by weight, preferably from 20 to 50% by weight, particularly preferably from 30 to 50% by weight, and the concentration of the 1,3-cyclohexanediamine in the absorption medium is from 5 to 40% by weight, preferably from 5 to 30% by weight, particularly preferably from 10 to 25% by weight.

The absorption medium preferably comprises an aqueous solution.

In one embodiment, the absorption medium comprises at least one organic solvent. The organic solvent is preferably selected from among sulfolane, glycols such as ethylene glycol, diethylene glycol, ethylene glycol dimethyl ether, triethylene glycol, triethylene glycol dimethyl ether, monoethylene glycol di(C₁₋₄-alkyl) or mono(C₁₋₄-alkyl) ethers and polyethylene glycol di(C₁₋₄-alkyl) or mono(C₁₋₄-alkyl) ethers, N-methyl-pyrrolidone, N-methyl-3-morpholine, N-formylmorpholine, N-acetylmorpholine, N,N-dimethylformamide, N,N-dimethylimidazolidin-2-one, N-methylimidazole and mixtures thereof.

The absorption medium comprises at least one tertiary amine and/or a sterically hindered primary or secondary amine in addition to the compound of the general formula (I).

For the purposes of the present invention, a “tertiary amine” is a compound having at least one tertiary amino group. The tertiary amine preferably comprises exclusively tertiary amino groups, i.e. it does not comprise any primary or secondary amino groups in addition to at least one tertiary amino group.

Suitable tertiary amines include, in particular:

1. tertiary alkanolamines such as
bis(2-hydroxyethyl)methylamine (methyldiethanolamine, MDEA), tris(2-hydroxyethyl)amine (triethanolamine, TEA), tributanolamine, 2-diethylaminoethanol (diethylethanolamine, DEEA), 2-dimethylaminoethanol (dimethylethanolamine, DMEA), 3-dimethylamino-1-propanol (N,N-dimethylpropanolamine), 3-diethylamino-1-propanol, 2-diisopropylaminoethanol (DIEA), N,N-bis(2-hydroxypropyl)methylamine (methyldiisopropanolamine, MDIPA);

2. tertiary amino ethers such as
3-methoxypropyldimethylamine;

3. tertiary polyamines, e.g. bis-tertiary diamines such as
N,N,N′,N′-tetramethylethylenediamine, N,N-diethyl-N′,N′-dimethylethylenediamine, N,N,N′,N′-tetraethylethylenediamine, N,N,N′, N′-tetramethyl-1,3-propanediamine (TMPDA), N,N,N′,N′-tetraethyl-1,3-propanediamine (TEPDA), N,N,N′,N′-tetramethyl-1,6-hexanediamine, N,N-dimethyl-N′,N′-diethylethylenediamine (DMDEEDA), 1-dimethylamino-2-dimethylaminoethoxyethane (bis[2-(dimethylamino)ethyl] ether), 1,4-diazabicyclo[2.2.2]octane (TEDA), tetramethyl-1,6-hexanediamine;

and mixtures thereof.

Tertiary alkanolamines, i.e. amines having at least one hydroxyalkyl group bound to the nitrogen atom, are generally preferred. Particular preference is given to methyldiethanolamine (MDEA).

For the purposes of the present invention, steric hindrance is the presence of at least one secondary or tertiary carbon atom in the immediate vicinity of the sterically hindered position. Such amines comprise not only sterically hindered amines but also compounds which in the prior art are referred to as strongly sterically hindered amines and have a steric parameter (Taft constant) Eₛ of more than 1.75.

For the purposes of the present invention, a secondary carbon atom is a carbon atom which has two carbon-carbon bonds in addition to the bond to the sterically hindered position. A tertiary carbon atom is a carbon atom which has three carbon-carbon bonds in addition to the bond to the sterically hindered position. A secondary amine is a compound having a nitrogen atom which is substituted by two organic radicals different from hydrogen (e.g. alkyl radical, alkenyl radical, aryl radical, alkylaryl radical, etc.).

Suitable sterically hindered primary or secondary amines are, for example, 2-(2-tert-butylaminoethoxy)ethanol (TBAEE), 2-(isopropylamino)ethanol (IPAE) and 2-amino-2-methylpropanol (2-AMP).

In particular embodiments, the absorption medium comprises at least one acid. The acid is appropriately selected from among protic acids (Brönsted acids). The acid is selected from among organic and inorganic acids. Suitable organic acids comprise, for example, phosphonic acids, sulfonic acids, carboxylic acids and amino acids. In particular embodiments, the acid is a polybasic acid.

Among inorganic acids, phosphoric acid and sulfuric acid are preferred.

Among carboxylic acids, formic acid, acetic acid, benzoic acid, succinic acid and adipic acid are preferred.

Among sulfonic acids, methanesulfonic acid, p-toluenesulfonic acid and 2-(4-(2-hydroxyethyl)-1-piperazinyl)ethanesulfonic acid (HEPES) are preferred.

Among phosphonic acids, 2-hydroxyphosphonoacetic acid, 2-phosphonobutane-1,2,4-tricarboxylic acid, 1-hydroxyethane-1,1-diphosphonic acid, ethylenediamine tetra(methylenephosphonic acid), diethylenetriaminepenta(methylenephosphonic acid), bis(hexamethylene)triaminepenta(methylenephosphonic acid) (HDTMP) and nitrilo-tris(methylenephosphonic acid) are preferred, and of these 1-hydroxyethane-1,1-diphosphonic acid is particularly preferred.

The absorption medium can also comprise additives such as corrosion inhibitors, enzymes, etc. In general, the amount of such additives is in the range from about 0.01 to 3% by weight of the absorption medium.

The absorption medium or process of the invention is suitable for the treatment of fluids of all types. Fluids are firstly gases such as natural gas, synthesis gas, coke oven gas, cracking gas, coal gasification gas, recycle gas, landfill gases and combustion gases and secondly liquids which are essentially immiscible with the absorption medium, e.g. liquefied gas fuel (LPG, liquefied petroleum gas) or liquefied natural gas (NGL, natural gas liquids). In one embodiment, the fluid stream is a flue gas stream, for example from combustion plants, production gases, synthesis gases or ambient air. These gases are formed, inter alia, in power stations, motor vehicles, production sites, ammonia production, epoxide production, cement production, the ceramics industry, coking plants, metal smelting, the steel industry, propellant exposure and air-conditioned working and living areas. Further CO₂-comprising fluid streams are fermentation gases from methane generation from biomasses, rotting gases from aerobic and/or anaerobic composting of biomasses, combustion gases, animal digestion gases in large-scale animal husbandry and CO₂-comprising ambient air in air conditioning of buildings and vehicles.

The fluid stream comprises carbon dioxide and/or hydrogen sulfite; it can additionally comprise further acidic gases such as COS and mercaptans. In addition, SO₃, SO₂, CS₂ and HCN can also be removed.

The compounds according to the invention of the general formula (I) are especially suitable in processes and absorption media for the treatment of hydrocarbon-comprising fluid streams. The hydrocarbons comprised are, for example, aliphatic hydrocarbons, e.g. C₁-C₄-hydrocarbons such as methane, unsaturated hydrocarbons such as ethylene or propylene or aromatic hydrocarbons such as benzene, toluene or xylene. The process of the invention is particularly suitable for treatment of a natural gas stream. The process or absorption medium of the invention is particularly suitable for removing CO₂.

In the process of the invention, the fluid stream is brought into contact with the absorption medium in an absorption step in an absorber, resulting in carbon dioxide and/or hydrogen sulfite being at least partly scrubbed out. A CO₂- or H₂S-depleted fluid stream and a CO₂- or H₂S-loaded absorption medium are obtained.

A scrubbing apparatus used in conventional gas scrubbing processes functions as absorber. Suitable scrubbing apparatuses are, for example, columns comprising packing elements, structured packing or trays, membrane contactors, radial flow scrubbers, jet scrubbers, Venturi scrubbers and rotational spray scrubbers, preferably columns comprising structured packing, packing elements or trays, particularly preferably columns comprising trays or packing elements. The treatment of the fluid stream with the absorption medium is preferably carried out in countercurrent in a column. The fluid is generally fed into the lower region and the absorption medium is fed into the upper region of the column. In tray columns, sieve trays, bubble cap trays or valve trays are installed and the liquid flows over these. Columns comprising packing elements can be filled with various shaped bodies. Heat transfer and mass transfer are improved by the enlargement of the surface area due to the shaped bodies which usually have a size of from about 25 to 80 mm. Known examples are the Raschig ring (a hollow cylinder), Pall ring, Hiflow ring, Intalox saddle and the like. The packing elements can be introduced into the column in an ordered manner or else in a disordered manner (as bed). Possible materials are glass, ceramic, metal and polymers. Structured packings are a further development of ordered packing elements. They have a regularly shaped structure. This makes it possible to reduce pressure drops in the gas flow in the case of packings. There are various embodiments of packings, e.g. mesh packings or metal sheet packings. As material, it is possible to use metal, polymer, glass and ceramic.

The temperature of the absorption medium in the absorption step is generally from about 30 to 100° C., when using a column for example from 30 to 70° C. at the top of the column and from 50 to 100° C. at the bottom of the column. The total pressure in the absorption step is generally from about 1 to 180 bar, preferably from about 1 to 100 bar.

The process of the invention can comprise one or more, e.g. two, successive absorption steps. The absorption can be carried out in a plurality of successive substeps, with the crude gas comprising the acidic gas constituents being brought into contact with a substream of the absorption medium in each of the substeps. The absorption medium with which the crude gas is brought into contact can already be partially loaded with acidic gases, i.e. it can, for example, be an absorption medium which has been recirculated from a subsequent absorption step to the first absorption step or be partially regenerated absorption medium. As regards the way in which the two-stage absorption is carried out, reference may be made to the documents EP 0 159 495, EP 0 190 434, EP 0 359 991 and WO 00100271.

The process preferably comprises a regeneration step in which the CO₂- and H₂S-loaded absorption medium is regenerated. In the regeneration step, CO₂ and H₂S and optionally further acidic gas constituents are liberated from the CO₂- and H₂S-loaded absorption medium, giving a regenerated absorption medium. The regenerated absorption medium is then preferably recirculated to the absorption step. In general, the regeneration step comprises at least one of the measures heating, depressurization and stripping with an inert fluid.

The regeneration step preferably comprises heating of the absorption medium loaded with the acidic gas constituents. The absorbed acidic gases are stripped out by means of the steam obtained by heating of the solution. Instead of the steam, it is also possible to use an inert fluid such as nitrogen. The absolute pressure in the desorber is normally from 0.1 to 3.5 bar, preferably from 1.0 to 2.5 bar. The temperature is normally from 50° C. to 170° C., preferably from 80° C. to 130° C., with the temperature naturally being dependent on the pressure.

The regeneration step can, as an alternative or in addition, comprise a depressurization. This comprises at least one depressurization of the loaded absorption medium from a high pressure as prevails when carrying out the absorption step to a low pressure. The depressurization can, for example, be effected by means of a throttle valve and/or a depressurization turbine. The regeneration with a depressurization stage is, for example, described in the documents U.S. Pat. Nos. 4,537,753 and 4,553,984.

The liberation of the acidic gas constituents in the regeneration step can be carried out, for example, in a depressurization column, e.g. a vertically or horizontally installed flash vessel or a countercurrent column having internals.

The regeneration column can likewise be a column comprising packing elements, structured packing or trays. The regeneration column has a heater, e.g. a boiler, natural circulation vaporizer, forced circulation vaporizer or forced circulation flash evaporator, at the bottom. At the top, the regeneration column has an outlet for the acidic gases liberated. Entrained absorption medium vapors are condensed in a condenser and recirculated to the column.

It is possible for a plurality of depressurization columns in which regeneration is carried out at different pressures to be connected in series. For example, regeneration can be carried out in a predepressurization column at high pressure, typically about 1.5 bar above the partial pressure of the acidic gas constituents in the absorption step, and in a main depressurization column at low pressure, for example from 1 to 2 bar.

Regeneration having two or more depressurization stages is described in the documents U.S. Pat. Nos. 4,537,753, 4,553,984, EP 0 159 495, EP 0 202 600, EP 0 190 434 and EP 0 121 109.

The invention will be illustrated in more detail with the aid of the attached drawings and the following examples.

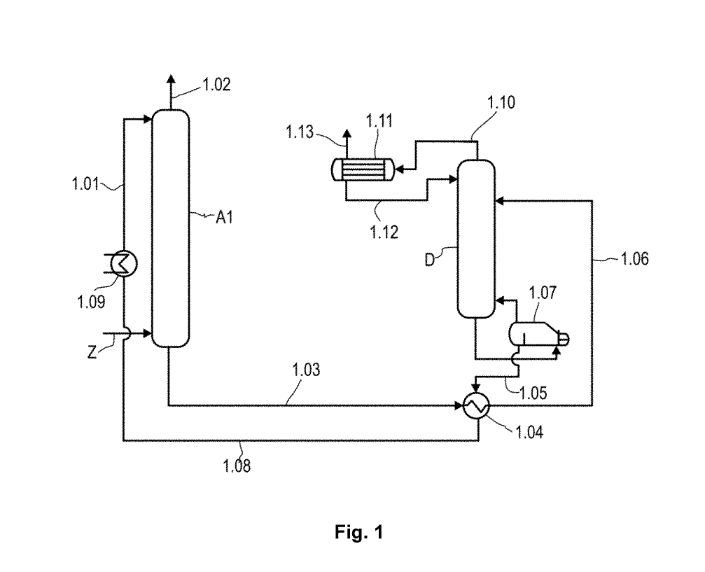

FIG. 1 schematically shows a plant suitable for carrying out the process of the invention.

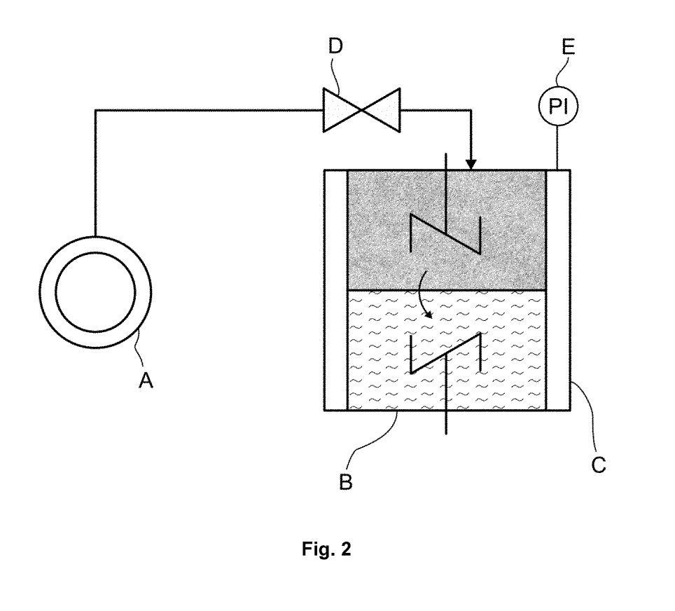

FIG. 2 schematically shows a double stirred cell arrangement used for determining the relative CO₂ absorption rates of absorption media.

According to FIG. 1, a suitably pretreated gas comprising hydrogen sulfite and/or carbon dioxide is fed via the feed line Z into an absorber Al in which it is brought into contact in countercurrent with regenerated absorption medium fed in via the absorption medium line 1.01. The absorption medium removes hydrogen sulfite and/or carbon dioxide from the gas by absorption; this gives a purified gas depleted in hydrogen sulfite and/or carbon dioxide via the offgas line 1.02.

The CO₂- and/or H₂S-loaded absorption medium is fed via the absorption medium line 1.03, the heat exchanger 1.04, in which the CO₂- and/or H₂S-loaded absorption medium is heated by means of the heat of the regenerated absorption medium conveyed via the absorption medium line 1.05, and the absorption medium line 1.06 into the desorption column D and regenerated. From the lower part of the desorption column D, the absorption medium is conveyed into the boiler 1.07 where it is heated. The mainly water-comprising vapor is recirculated to the desorption column D, while the regenerated absorption medium is conveyed via the absorption medium line 1.05, the heat exchanger 1.04, in which the regenerated absorption medium heats the CO₂- and/or H₂S-loaded absorption medium and is in the process cooled, the absorption medium line 1.08, the cooler 1.09 and the absorption medium line 1.01 back into the absorber A1. Instead of the boiler shown, it is also possible to use other types of heat exchanger, e.g. a natural circulation vaporizer, forced circulation vaporizer or forced circulation flash evaporator, for generating the stripping steam. In these types of vaporizer, a mixed-phase stream composed of regenerated absorption medium and stripping steam is fed back into the bottom of the desorption column where phase separation between the vapor and the absorption medium takes place. The regenerated absorption medium to the heat exchanger 1.04 is either taken off from the circulation stream at the bottom of the desorption column to the vaporizer or is conveyed directly via a separate line from the bottom of the desorption column to the heat exchanger 1.04.

The CO₂- and/or H₂S-comprising gas liberated in the desorption column D leaves the desorption column D via the offgas line 1.10. It is fed into a condenser with integrated phase separation 1.11 where it is separated from accompanying absorption medium vapor. Condensation and phase separation can also be separate from one another. A liquid consisting mainly of water is subsequently conveyed via the absorption medium line 1.12 into the upper region of the desorption column D, and a CO₂- and/or H₂S-comprising gas is discharged via the gas line 1.13.

In FIG. 2, the following reference symbols are used: A=CO₂ storage vessel, B=double stirred cell, C=temperature regulator, D=metering valve, E=pressure measuring device. According to FIG. 2, a liquid phase of the absorption medium to be tested, which is in contact via a phase boundary with the gas phase located above, is present in the lower part of the double stirred cell B. The liquid and gas phases can each be mixed by means of a stirrer. The double stirred cell B is connected via a metering valve D to the CO₂ storage vessel A. The pressure prevailing in the double stirred cell B can be determined by means of the pressure measuring device E. In the measurement, the volume flow of the carbon dioxide is recorded, with the volume flow being set so that a constant pressure prevails in the double stirred cell B.

### EXAMPLES

The following abbreviations are used:
DSC: double stirred cell
PIP: piperazine
MDACH: 4-methylcyclohexane-1,3-diamine
MDEA: methyldiethanolamine
TBAEE: 2-(2-tert-butylaminoethoxy)ethanol
MEA: monoethanolamine

### Example 1

The relative CO₂ absorption rates of aqueous absorption media were measured in a double stirred cell (DSC) as shown in FIG. 2.

The double stirred cell had an internal diameter of 85 mm and a volume of 509 ml. The temperature of the cell was maintained at 50° C. during the measurements. To mix the gas and liquid phases, the cell as shown in FIG. 2 comprised two stirrers. Before commencement of the measurement, the double stirred cell was evacuated. A defined volume of degassed absorption medium was introduced into the double stirred cell and the temperature was regulated to 50° C. The stirrers were switched on during heating of the unloaded absorption medium. The rotational speed of the stirrers was selected so that a planar phase boundary was formed between the liquid phase and the gas phase. Formation of waves at the phase boundary has to be avoided since otherwise there would be no defined phase boundary. After the desired experimental temperature had been reached, carbon dioxide was introduced into the reactor by means of a metering valve. The volume flow was controlled so that a constant pressure of 50 mbar abs, corresponding to a CO₂ partial pressure of 50 mbar abs, prevailed during the entire experiment. As the running time of the experiment increased, the volume flow decreased since the absorption medium became saturated over time and the absorption rate decreased. The volume flow was recorded over the entire time. The experiment was stopped as soon as no more carbon dioxide flowed into the measurement cell. The absorption medium was virtually in an equilibrium state at the end of the experiment.

To carry out the evaluation, the absorption rate in mol(CO₂)/(m³_{absorption medium}* min) was calculated as a function of the loading of the absorption medium. The absorption rate was calculated from the volume flow of the carbon dioxide and the initially charged volume of absorption medium. The loading was calculated from the cumulated amount of carbon dioxide fed into the measurement cell and the initially charged mass of absorption medium.

The results are shown in the following table:

| | Absorption | CO₂ absorption rate | | |
|---|---|---|---|---|
| | medium | at 75% | at 50% | at 20% |
| Example | (% by weight) | final loading | final loading | final loading |
| 1-1* | TBAEE/PIP | 1.9 | 4.7 | 5.9 |
| | (37/10) | | | |
| 1-2 | TBAEE/MDACH | 1.4 | 3.7 | 5.2 |
| | (36/17) | | | |
| 1-3* | MDEA/PIP | 0.8 | 1.7 | 2.8 |
| | (34/6) | | | |
| 1-4 | MDEA/MDACH | 0.7 | 1.3 | 2.0 |
| | (33/10) | | | |

*comparative example

Examples 1-1 and 1-2 and, respectively, 1-3 and 1-4 contained comparable molar amounts of amine. It can be seen that the MDACH-comprising absorption media display comparable CO₂ absorption rates to the PIP-comprising comparative compositions. MDACH is thus suitable as activator for the absorption of CO₂.

### Example 2

To estimate the cyclic capacity, a loading experiment and a subsequent stripping experiment were carried out for the following aqueous absorption media: as apparatus, a thermostated glass cylinder having a superposed reflux condenser was used. The reflux condenser was operated at a temperature of about 5° C. and prevented water and amine from being discharged during loading or stripping.

100 ml of the absorption medium were in each case introduced into the glass cylinder at 40° C. 20 standard l/h of pure CO₂ were bubbled into the absorption solution via a frit at the lower end of the glass cylinder for about 4 hours. The loading of CO₂ in the absorption medium was subsequently determined by measuring the content of total inorganic carbon (TOC-V series Shimadzu).

The loaded solutions were then stripped by means of nitrogen (20 standard l/h) at 80° C. in an apparatus having an identical structure. After 60 minutes, a sample of the absorption medium was taken and analyzed to determine the CO₂ content. The difference between the CO₂ loading attained at the end of the loading experiment and that at the end of the stripping experiment give the cyclic capacities of the absorption media.

The results are shown in the following table.

| | | CO₂ loading | CO₂ loading | Cyclic |
|---|---|---|---|---|
| | | after loading | after stripping | capacity |
| | | (standard | (standard | (standard |
| Run | Absorption medium | m³/t) | m³/t) | m³/t) |
| 2-1* | 34% by weight of | 55.3 | 14 | 43.9 |
| | MDEA + 6% by | | | |
| | weight of PIP | | | |
| 2-2 | 33% by weight of | 63.8 | 11.4 | 49.8 |
| | MDEA + 10% by | | | |
| | weight of MDACH | | | |
| 2-3* | 45% by weight of | 63.5 | 19.2 | 44.3 |
| | TBAEE + 10% by | | | |
| | weight of PIP | | | |
| 2-4* | 20% by weight of MEA | 45.9 | 30.0 | 15.9 |
| 2-5 | 20% by weight of | 46.0 | 19.5 | 26.5 |
| | MDACH | | | |

*comparative example

It can be seen that the example 2-2 (MDEA/MDACH) according to the invention displays a higher cyclic capacity than comparative example 2-1 which contains piperazine instead of MDACH as activator. Example 2-5 shows that an MDACH-comprising absorption medium has a higher cyclic capacity than an absorption medium comprising the primary alkanolamine MEA (comparative example 2-4).

### Example 3

To determine the crystallization temperature of the absorption medium, a test tube was filled with about 5-20 ml of unloaded absorption medium. A thermometer was introduced for stirring and to measure the temperature. The system was firstly homogenized in the liquid phase and then slowly cooled until solids formation was observed. At this instant, the test tube was taken out from the cooling bath and the temperature was allowed to rise slowly. The temperature at which the solid had completely redissolved and only a liquid phase was present was noted. The operation was carried out three times for each sample.

The results are shown in the following table.

| | Crystallization |
|---|---|
| Absorption medium (% by weight) | temperature (° C.), unloaded |
| MDEA/MDACH (33/10) | −14.0 |
| MDEA/PIP (34/6) | 7.0 |
| TBEAA/MDACH (45/10) | −23.0 |

The MDACH-comprising absorption media display advantageously low crystallization temperatures.

1-15. (canceled)

16. A removal process, comprising removing carbon dioxide from a fluid stream with 1,3-diaminocyclohexane of formula (I): 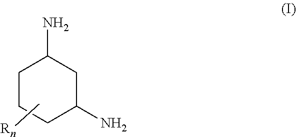
wherein
the radicals R are each, independently of one another, C₁₋₄-alkyl; and
n is 1 or 2.

17. The process according to claim 16, wherein the 1,3-diaminocyclohexane is a compound of formula (Ia) or (Ib) or a mixture thereof:

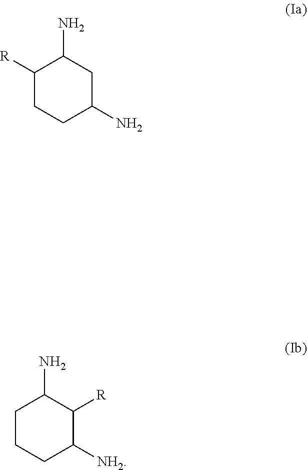

18. The process according to claim 16, wherein the amino groups of the 1,3-diaminocyclohexane are arranged in trans position relative to one another in the plane of the cyclohexane ring.

19. An absorption medium in the form of an aqueous solution, comprising
a) a 1,3-diaminocyclohexane of formula (I): 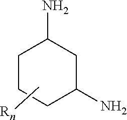
wherein the radicals R are each, independently of one another, C₁₋₄-alkyl; and n is 1 or 2; and
b) optionally at least one tertiary amine and/or a sterically hindered primary or secondary amine.

20. The absorption medium according to claim 19, wherein each of the radicals R is arranged in the a position relative to at least one amino group.

21. The absorption medium according to claim 20, wherein the 1,3-diaminocyclohexane is a compound of the formula (Ia) or (Ib) or a mixture thereof

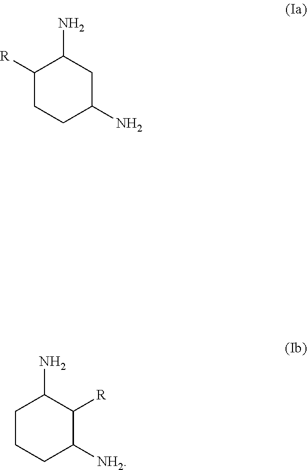

22. The absorption medium according to claim 21, wherein the 1,3-diaminocyclohexane of formula (I) is 4-methylcyclohexane-1,3-diamine, 2-methylcyclohexane-1,3-diamine or a mixture thereof.

23. The absorption medium according to claim 19, wherein the amino groups of the 1,3-diaminocyclohexane are arranged in trans positions relative to one another in the plane of the cyclohexane ring.

24. The absorption medium according to claim 19, wherein the absorption medium comprises at least one organic solvent selected from the group consisting of sulfolane, glycols, N-methylpyrrolidone, N-methyl-3-morpholine, N-formylmorpholine, N-acetylmorpholine, N,N-dimethylformamide, N,N-dimethylimidazolidin-2-one, N-methylimidazole and mixtures thereof.

25. The absorption medium according to claim 19, wherein the tertiary amine and/or sterically hindered primary or secondary amine are selected from among alkanolamines.

26. The absorption medium according to claim 25, wherein the tertiary amine is methyldiethanolamine and the sterically hindered secondary amine is tert-butylaminoethoxyethanol.

27. A process for removing carbon dioxide from fluid streams, comprising contacting an absorption medium according to claim 19 with a fluid stream.

28. The process according to claim 27, wherein the fluid stream comprises hydrocarbons.

29. The process according to claim 27, wherein the loaded absorption medium is regenerated by at least one of the measures heating, depressurization and stripping via an inert fluid.
